(19) United States
(12) Patent Application Publication
(10) Pub. No.: US 2014/0191940 A1
(43) Pub. Date: Jul. 10, 2014

(54) VEHICLE DISPLAY ARRANGEMENT AND VEHICLE COMPRISING A VEHICLE DISPLAY ARRANGEMENT

(71) Applicant: VOLVO CAR CORPORATION, Gothenburg (SE)

(72) Inventor: Claes Edgren, Trollhattan (SE)

(73) Assignee: VOLVO CAR CORPORATION, Gothenburg (SE)

(21) Appl. No.: 14/079,851

(22) Filed: Nov. 14, 2013

(30) Foreign Application Priority Data
Jan. 8, 2013 (EP) 13150475.5

(51) Int. Cl. G06F 3/01

(52) U.S. Cl. CPC G06F 3/012
USPC 345/156

(57) ABSTRACT

A display arrangement for a vehicle is provided. The arrangement may include a display for displaying information to a vehicle operator, and a sensor for monitoring a head position of a vehicle operator and generating input signals indicative of the vehicle operator head position. The arrangement may also include a control unit arranged to automatically initiate, based on an interpretation of the input signals, at least one of a dimension change of graphical display objects or a change of the relation between the graphical display objects following a monitored predefined change of the vehicle operator head position in a first direction, such that graphical display objects previously displayed as partly hidden are arranged to be displayed as visible.

### CROSS-REFERENCE TO RELATED APPLICATIONS

This application claims priority to European Patent Application No. 13150475.5 filed Jan. 8, 2013, the disclosure of which is incorporated in its entirety by reference herein.

### TECHNICAL FIELD

Embodiments herein relate to a vehicle display arrangement. Embodiments herein further relate to a vehicle comprising a vehicle display arrangement.

### BACKGROUND

Many of today's motor vehicles are equipped with a number of analogue instruments and one or more digital displays, for displaying information to a vehicle operator. The information on the display may concern a vehicle condition, such as vehicle speed, engine speed, motor temperature, distance to refuel etc. The display may also present information concerning driving related conditions, such as outer temperature, skidding risk, information regarding navigation or communication information, such as phone calls or messages of various kinds. Based on the information revealed, the vehicle operator can take decisions, such as when to refuel or where to take a turn.

Certain information is presented constantly to the vehicle operator and other information is available only after interaction with display control means. If the driver seeks information not constantly presented, he/she may have to push a button or interact with a touch screen in order to access the temporary required information. It is a challenge to arrange a user interface where the driver is presented a balanced load of information on a display. Further, since a great load of information often is available, it is also a challenge for the vehicle operator to access desired and temporarily required information, without losing focus on the task of driving.

In order to allow the vehicle operator to interact with the vehicle, WO2011155878A1 suggests a driver head tracking system, with a sensor for monitoring the driver's head position or gaze direction. The system is arranged to modify the displayed information depending on the driver's head position or gaze direction, and if the driver moves his head forward, a virtual instrument cluster is moved downwards, allowing new information to be added at the bottom of a cluster screen.

The driver head tracking system according to WO2011155878A1 functions according to a keyhole principle; when the driver looks at the screen from one direction he can see one information area, when he looks at the screen from another direction, he can see another information area. This can be advantageous in certain situations, but improvements in the field of vehicle user interface and display arrangements are still desirable.

### SUMMARY

Embodiments herein aim to provide a vehicle display arrangement for a vehicle operator without the problems or drawbacks described above.

According to a first aspect, the object is achieved by a vehicle display arrangement comprising a display for displaying information to a vehicle operator, one or more sensors for monitoring a vehicle operator head position, communication means arranged to communicate input signals indicative of the vehicle operator head position to a processing unit, wherein the processing unit is arranged to interpret the input signals and, based on the interpretation of the input signals, communicate output signals to a control unit via the communication means, the control unit being arranged to automatically initiate at least one of a dimension change of graphical display objects or a change of the relation between the graphical display objects following a monitored predefined change of the vehicle operator head position in a first direction, such that previously displayed as partly hidden graphical display objects are arranged to be displayed as visible in a first predefined manner.

Since the processing unit is arranged to interpret the input signals and, based on the interpretation of the input signals, communicate output signals to a control unit via the communication means, the control unit being arranged to automatically initiate at least one of a dimension change of graphical display objects or a change of the relation between the graphical display objects following a monitored predefined change of the vehicle operator head position in a first direction, such that previously displayed as partly hidden graphical display objects are arranged to be displayed as visible in a first predefined manner, the vehicle operator will achieve a change of display information by moving his head. Therefore, selected graphical display objects which comprise information will be displayed to the vehicle operator in an easy and intuitive manner.

Thanks to this, a vehicle operator is able to keep his/her hands at a steering wheel in an ordinary driving position and will not have to move one hand from the steering wheel to a button, knob or the like in order to access information not constantly displayed. The vehicle operator can simply change his head position in a first direction in order to let the display temporarily present this information.

Another advantage is that a display configuration generally displayed to the vehicle operator can be configured to only present important or frequently required information. When additional graphical display objects are required for displaying information temporarily needed, the vehicle operator can easily access the information through a change of head position in the first direction.

In addition to the above mentioned advantages, initiation of at least one of a dimension change of graphical display objects and a change of the relation between the graphical display objects in a predefined manner, by changing vehicle head operator position, will facilitate the user-vehicle interaction since the vehicle operator cognitively will connect the change of head position with the change on the display. A change of the dimensions of graphical display objects and/or the change of the relation between the graphical display objects in a predefined manner by a change of head position is an easy and intuitive way of controlling the information on the display. According to some embodiments, the dimension change of graphical display objects and/or the relation between the graphical display objects is arranged such that the graphical display objects will be perceived to be adjusted in a direction substantially corresponding to the first direction, which further will enhance an understanding of how head movement will affect the information presented on the display.

This result in a vehicle display arrangement for a vehicle operator that the vehicle operator can interact with without the problems or drawbacks described above, and therefore the above mentioned object is achieved.

According to a second aspect, the object is achieved by a vehicle display arrangement wherein the control unit is arranged to automatically initiate at least one of a dimension change of graphical display objects or a change of the relation between the graphical display objects following a monitored predefined change of the vehicle operator head position in a second direction such that previously displayed as partly hidden graphical display objects are arranged to be displayed as visible in a second predefined manner.

Since the control unit is arranged to automatically initiate at least one of a dimension change of graphical display objects or a change of the relation between the graphical display objects following a monitored predefined change of the vehicle operator head position in a second direction, such that previously displayed as partly hidden graphical display objects are arranged to be displayed as visible in a second predefined manner, selected graphical display objects will be displayed in an easy and intuitive manner. The vehicle operator can change his head position in the second direction in order to let the display present information temporarily. Thanks to this, a display configuration generally displayed to the vehicle operator can be configured to only present important or frequently needed information. When additional graphical display objects are needed, for displaying temporarily needed information, the vehicle operator can easily access the information through a change of head position in the second direction.

According to a third aspect, the object is achieved by a vehicle display arrangement wherein the control unit is arranged to automatically initiate at least one of a dimension change of graphical display objects or a change of the relation between the graphical display objects following a monitored predefined change of the vehicle operator head position in a first or second direction such that previously displayed as partly hidden graphical display objects, arranged as a side on a virtual cube, are arranged to be displayed as visible.

Since the control unit is arranged to automatically initiate at least one of a dimension change of graphical display objects or a change of the relation between the graphical display objects following a monitored predefined change of the vehicle operator head position in a first or second direction, such that previously displayed as partly hidden graphical display objects, arranged as a side on a virtual cube, are arranged to be displayed as visible, graphical display objects can be displayed in an easy and intuitive manner. The vehicle operator can change his head position in the first or second direction in order to be able to see graphical display objects arranged as a side on a virtual cube.

The presentation of the graphical display objects arranged as a side on a virtual cube can further enhance an understanding of how head movement will affect the information presented on the display, since the movement of the head corresponds to the action a person generally would have taken in order to retrieve information arranged on a side that not is initially facing the person on a physical cube.

Since the vehicle display arrangement is arranged to let a user use a movement pattern he/she would have used when studying a physical object for gaining information presented on a corresponding digital object in form of graphical display objects on a display, he/she can easy cognitively connect a two dimensional display presentation with his/hers perception adapted for a three-dimensional space. He/she can then, thanks to changes on the display as a result of his head movement, perceive the display to present a three dimensional cube where he/she easily can access selected information by looking at the virtual cube from a head position other than his ordinary head position.

According to a fourth aspect, the object is achieved by a vehicle display arrangement wherein the control unit is arranged to automatically initiate at least one of a dimension change of graphical display objects or a change of the relation between the graphical display objects following a monitored predefined change of the vehicle operator head position in a first or second direction such that previously displayed as partly hidden graphical display objects, arranged as a stack, are arranged to be displayed as visible.

Since the control unit is arranged to automatically initiate at least one of a dimension change of graphical display objects or a change of the relation between the graphical display objects following a monitored predefined change of the vehicle operator head position in a first or second direction, such that previously displayed as partly hidden graphical display objects, arranged as a stack, are arranged to be displayed as visible, graphical display objects can be displayed in an easy and intuitive manner. The vehicle operator can change his head position in the first or second direction in order to be able to see graphical display objects arranged as a stack.

The presentation of the graphical display objects arranged as a stack will further enhance an understanding of how head movement will affect the information presented on the display, since the movement of the head will change the configuration of the virtual stack. When changing head position, the dimensions and/or the relation between the graphical display objects initially arranged on top of each other or behind each other as objects in a stack, will change, such as information related to the graphical display objects not initially presented can be presented.

According to a fifth aspect, the object is achieved by a vehicle display arrangement wherein the control unit is arranged to automatically initiate at least one of a dimension change of graphical display objects or a change of the relation between the graphical display objects following a monitored predefined change of the vehicle operator head position in a first or second direction such that previously displayed as partly hidden graphical display objects, arranged as sides of a virtual sphere, are arranged to be displayed as visible.

Since the control unit is arranged to automatically initiate at least one of a dimension change of graphical display objects or a change of the relation between the graphical display objects, following a monitored predefined change of the vehicle operator head position in a first or second direction, such that previously displayed as partly hidden graphical display objects, arranged as sides of a virtual sphere, are arranged to be displayed as visible, selected graphical display objects will be displayed in an easy and intuitive manner. The vehicle operator can change his head position in the first or second direction in order to be able to see graphical display objects arranged as a side on a virtual sphere.

The presentation of the graphical display objects arranged as a side on a virtual sphere will further enhance an understanding of how head movement will affect the information presented on the display, since the movement of the head corresponds to the action a person generally would have taken in order to retrieve information arranged on a side that not is initially facing the person on a physical sphere.

Since the vehicle display arrangement is arranged to let a user use a movement pattern he would have used when studying a physical object, for gaining information presented on a corresponding digital object in form of graphical display objects on a display, he can easy cognitively connect a two dimensional display presentation with his perception adapted for a three-dimensional space. He/she can then, thanks to changes on the display as a result of his/her head movement, perceive the display to present a three dimensional sphere where he/she easily can access selected information by looking at the virtual sphere from a head position other than his/her ordinary head position.

According to a sixth aspect, the object is achieved by a vehicle display arrangement wherein the control unit is arranged to automatically initiate at least one of a dimension change of graphical display objects or a change of the relation between the graphical display objects in a first predefined manner following a monitored predefined change of the vehicle operator head position in a first or second direction, thereby being arranged to automatically display conditions in an apparatus or system in a manner that allows perception of the presentation on the display to be three dimensional.

Since the control unit is arranged to automatically initiate at least one of a dimension change of graphical display objects or a change of the relation between the graphical display objects in a first predefined manner following a monitored predefined change of the vehicle operator head position in a first or second direction, thereby being arranged to automatically display conditions in an apparatus or system in a manner that allows perception of the presentation on the display to be three dimensional, a vehicle operator will cognitively connect a two dimensional display presentation with his/her perception adapted for a three-dimensional space. He/she will then, thanks to changes on the display as a result of his/her head movement, perceive the display to present a three dimensional presentation where he/she easily can access selected information by looking at the virtual presentation from a head position other than his/he ordinary head position.

Automatic display of conditions in an apparatus or system in a three dimensional manner will facilitate for a vehicle operator to operate the vehicle in an easy and safe manner.

According to a seventh aspect, the object is achieved by a vehicle display arrangement wherein the control unit is arranged to automatically initiate at least one of a dimension change of graphical display objects or a change of the relation between the graphical display objects following a monitored predefined change of the vehicle operator head position in a first direction, thereby being arranged to modify the display from a first display configuration into a second temporary display configuration.

Since the control unit is arranged to automatically initiate at least one of a dimension change of graphical display objects or a change of the relation between the graphical display objects following a monitored predefined change of the vehicle operator head position in a first direction, thereby being arranged to modify the display from a first display configuration into a second temporary display configuration, a vehicle operator can use his head position in order to access a second temporary display configuration.

This will be very useful when he/she desires to access information displayed on second temporary display configuration, for example information that he/she only requires temporarily or from time to time. It could be information regarding a vehicle condition or other information of interest for the vehicle operator, such as navigation instructions, conditions in a vehicle environment, or messages of any kind.

According to an eight aspect, the object is achieved by a vehicle display arrangement wherein the control unit is arranged to automatically initiate at least one of a dimension change of graphical display objects or a change of the relation between the graphical display objects following a monitored predefined change of the vehicle operator head position in a direction opposite the first direction, thereby being arranged to modify the display from a second temporary display configuration into the first configuration.

Since the control unit is arranged to automatically initiate at least one of a dimension change of graphical display objects or a change of the relation between the graphical display objects following a monitored predefined change of the vehicle operator head position in a direction opposite the first direction, thereby being arranged to modify the display from a second temporary display configuration into the first configuration, a vehicle operator can use his head position to change a second temporary display configuration into a first display configuration.

This will be very useful when the second temporary display configuration is present and the vehicle operator desires to access information displayed on the first display configuration.

According to a ninth aspect, the object is achieved by a vehicle that comprises a vehicle display arrangement.

Since a vehicle that comprises a vehicle display arrangement will facilitate for a vehicle operator to interact with the vehicle, or various systems or arrangements related to the vehicle, the above mentioned object is achieved.

Further features of, and advantages with, the embodiments herein will become apparent when studying the appended claims and the following detailed description. Those skilled in the art will realize that different features of the embodiments herein may be combined to create embodiments other than those described in the following, without departing from the scope of the appended claims.

### BRIEF DESCRIPTION OF THE DRAWINGS

The various aspects of embodiments herein, including its particular features and advantages, will be readily understood from the following detailed description and the accompanying drawings, in which:

FIG. 1 illustrates a schematic view of the vehicle display arrangement according to some embodiments

FIG. 2 illustrates a vehicle display arrangement according to some embodiments.

FIG. 3 illustrates a vehicle display arrangement according to some embodiments.

FIG. 4 illustrates a vehicle display arrangement according to some embodiments.

FIG. 5 illustrates a vehicle display arrangement according to some embodiments.

FIG. 6 illustrates a vehicle display arrangement according to some embodiments.

### DETAILED DESCRIPTION

Embodiments herein will now be described more fully with reference to the accompanying drawings, in which example embodiments are shown. However, this application should not be construed as limited to the embodiments set forth herein. Disclosed features of example embodiments can be combined as readily understood by one of ordinary skill in the art to which this application belongs. The figures are not necessarily to scale and features may be exaggerated or minimized to show details of particular components. Like numbers refer to like elements throughout. Well-known functions or constructions will not necessarily be described in detail for brevity and/or clarity.

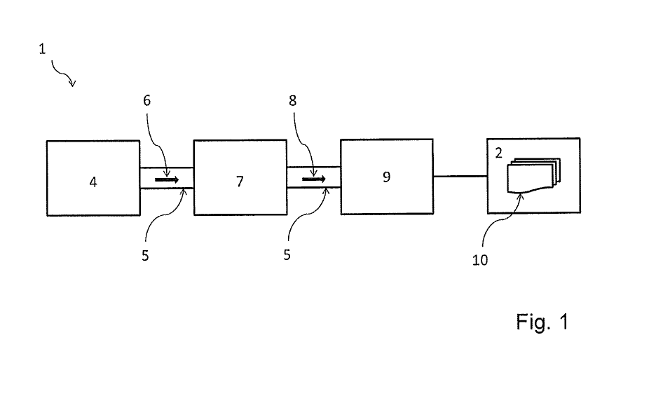

FIG. 1 illustrates a vehicle display arrangement 1 according to some embodiments. The vehicle display arrangement 1 comprises one or more sensors 4 for monitoring a vehicle operator head position and communication means 5 arranged to communicate input signals 6 indicative of the vehicle operator head position from the sensor or sensors 4 to a processing unit 7. The processing unit 7 is arranged to interpret the input signals 6 and, based on the interpretation of the input signals 6, communicate output signals 8 to a control unit 9 via the communication means 5. The control unit 9 is arranged to automatically initiate at least one of a dimension change of graphical display objects 10 on the display 2 or a change of the relation between the graphical display objects 10 following a monitored predefined change of the vehicle operator head position (not shown).

In alternative embodiments the one or more sensors 4 are part of a sensor arrangement, such as a vehicle operator tracking device capable of detecting a vision characteristic of a face and/or a head of the vehicle operator, such as an infrared camera or a digital camera, arranged to monitor for example head position, gaze direction or face direction of the vehicle operator.

According to some embodiments the one or more sensors 4 is arranged on or in the vicinity of a windshield, ceiling, dashboard or pillar, and according to some embodiments sensors used in other vehicle systems are used also for tracking the vehicle operator head position. The input signals 6 are electrical signals, arranged to be emitted when the one or more sensors 4 detect a change of vehicle operator head position. The input signal 6 is sent via Bluetooth, Wi-Fi, CAN bus or any other wired or wireless communication means, or via a combination of these.

The processing unit 7 is arranged to receive and interpret the signals 6 from the one or more sensors 4. The processing unit 7 can be an electronic computer of any kind, programmed to execute arithmetic and logical operations, and according to some embodiments the processing unit 7 includes a CPU, memory units, and integrated circuits. According so some embodiments the processing unit 7 is a separate processing unit, and in other embodiments the processing unit is integrated in any other vehicle processing unit. According so some embodiments the processing unit 7 is a part of a vehicle infotainment unit, such as an infotainment head unit, IHU. According so some embodiments the output signals 8 are electrical signals, sent via Bluetooth, Wi-Fi, CAN bus or any other wired or wireless communication means, or via a combination of these.

The control unit 9 is arranged to automatically initiate at least one of a dimension change of graphical display objects 10 on the display 2 or a change of the relation between the graphical display objects 10. According so some embodiments the control unit 9 is a separate control unit, and in other embodiments the control unit 9 is integrated in any other vehicle control unit. According to some embodiments the control unit 9 is part of a vehicle infotainment unit, such as an infotainment head unit, IHU.

The initiation of at least one of a dimension change of graphical display objects 10 on the display 2 or a change of the relation between the graphical display objects 10 is based on the output signal 8, sent from the processing unit 7 via the communication means 5. The control unit 9 is arranged as a separate unit or a unit integrated with the processing unit 7. If the control unit 9 and the processing unit 7 are integrated, the output signal 8 is sent between different unit parts within the processing unit.

The display 2 can be any kind of display suitable for presenting information to a vehicle operator or passenger. In some embodiments the display 2 is arranged on a dashboard, a steering wheel, centerstack or any other position suitable for presenting information to a vehicle operator. The display 2 is for example a touch screen, a LCD display, a LED display, a head-up-display or similar. In some embodiments the graphical display objects 10 are presented at one or more displays 2 simultaneously and graphical display objects 10 with different kinds of information can be presented on different displays 2.

The one or more sensors 4, the communication means 5, the processing unit 7, the control unit 9 and the display 2 are comprised in a vehicle display arrangement 1.

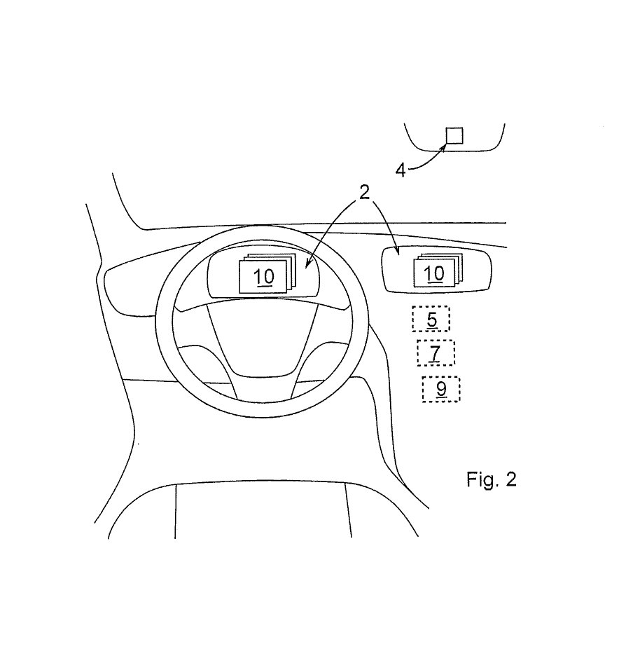

FIG. 2 illustrates a vehicle display arrangement 1 according to some embodiments. The vehicle display arrangement 1 comprises a display 2 for displaying information to a vehicle operator 3 (not shown) and one or more sensors 4 for monitoring a vehicle operator head position. Communication means 5 are arranged to communicate input signals 6 indicative of the vehicle operator head position to a processing unit 7, and the processing unit 7 is arranged to interpret the input signals 6. Based on the interpretation of the input signals 6, the processing unit 7 communicates output signals 8 to a control unit 9 via the communication means 5. The control unit 9 is arranged to modify the information presented on the vehicle display 2.

In FIG. 2, the display 2 is arranged in the vicinity of the dashboard in front of a seated vehicle operator (not shown) and/or in a position in a central part of the dashboard. In some embodiments the display 2 comprises two or more display surfaces arranged together or in different positions in the vehicle.

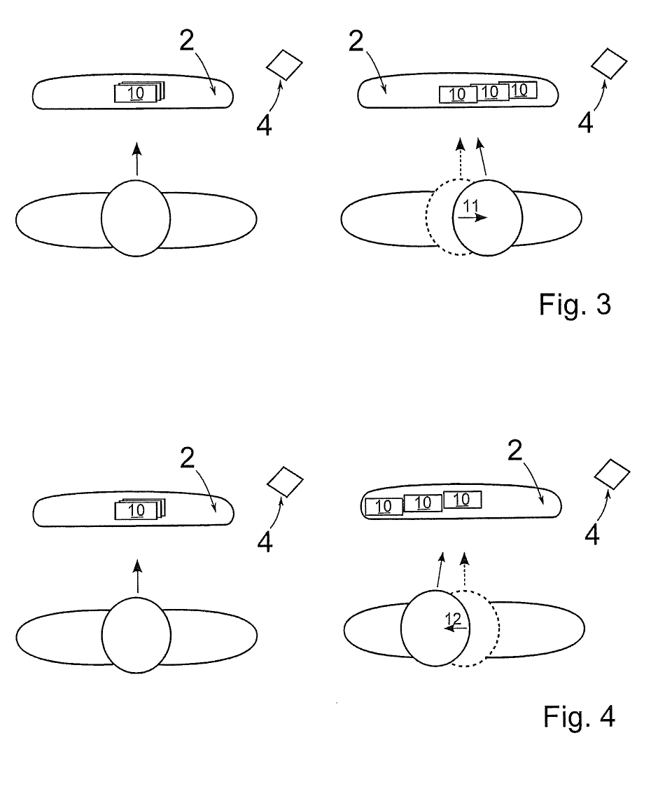

FIG. 3 illustrates a vehicle display arrangement 1 according to some embodiments. In the left part of FIG. 3, a vehicle operator is positioned in an ordinary driving position. When seated in a driver's seat, facing forward in the longitudinal direction of the vehicle, he/she will see the display 2 in front of him/her. Graphical display objects 10 are illustrated on the display 2. The graphical display objects 10 comprise different kinds of information. The information is for example related to a vehicle or environment condition such as vehicle speed, engine speed, active gear etc. The vehicle display arrangement 1 is adapted to present any useful information that the vehicle operator needs in a driving situation.

If the vehicle operator would like to gain temporary information regarding a condition not presented, he can do this by changing his head position in a first direction 11, as illustrated in the right part of FIG. 3. The one or more sensors 4 are sensing the change of head position or gaze direction and the graphical display objects 10 are changed such that previously displayed as partly hidden graphical display objects 10 are displayed as visible. The vehicle operator can then access information not previously displayed.

With partly hidden graphical display objects 10 means that at least a part or portion of the graphical display objects 10 is hidden to the vehicle operator and at least a part of the graphical display objects 10 is displayed to the vehicle operator. According to some embodiments, only a small part, such as one or a few percent of the graphical display objects 10 is hidden. According to some embodiments, only a small part, such as one or a few percent of the graphical display objects 10 is displayed.

According to the embodiment illustrated in FIG. 3, the graphical display objects 10 are partly overlapping each other in both the left and right part of the figure.

In one example, the graphical display objects 10, according to the left part of FIG. 3, comprises an instruction, and in order to see the next instruction, the vehicle operator can change his head position in a first direction 11, as illustrated in the right part of FIG. 3. Thus, only the most important or relevant information will be displayed to the vehicle operator at any time, and if he/she would like to gain additional information he/she can easily do so by looking at the display 2 from another direction.

The change of viewing angle is illustrated in the right part of FIG. 3, where the dashed lines illustrates the ordinary vehicle operator position before the change of head position, and the filled lines illustrates the vehicle operator position after the change of head position. The viewing angle is referred to as the angle between a vehicle operator gaze direction and a plane substantially in parallel with a display surface.

The change of viewing angle required for a change of the graphical display objects 10 can be adjustable according to the preferences of a vehicle operator. According to some embodiments, just a change of viewing angle of one or a few degrees will be sufficient, in other embodiments a larger change of viewing angle could be required, such as a few degrees up to 45 or more degrees.

According to FIG. 3, the graphical display objects 10 are arranged as a stack, where the different graphical display objects 10 are arranged on top of each other or partly on top of each other when the vehicle operator is looking at the graphical display objects 10 from an ordinary driving position, and the different graphical display objects 10 can be arranged beside each other or partly overlapping when the vehicle operator head position moves in a first direction 11. The first direction is illustrated with arrow 11 in FIG. 3.

In one example, the vehicle display arrangement 1 is arranged such that the graphical display objects 10, according to the left part of FIG. 3, comprises information regarding the traffic situation in the vicinity of the vehicle, and in order to see information regarding the traffic situation ahead of the vehicle the vehicle operator will have to change his head position in a first direction 11, as illustrated in the right part of FIG. 3. The information is stored in a vehicle related system or is sent to the vehicle from a traffic information centre or similar.

In one example, the vehicle display arrangement 1 is arranged such that the graphical display objects 10, according to the left part of FIG. 3, comprise information regarding fuel consumption or current vehicle speed, and in order to see information regarding distance to empty or average vehicle speed the vehicle operator will have to change his head position in a first direction 11, as illustrated in the right part of FIG. 3.

In one example, the vehicle display arrangement 1 is arranged such that the graphical display objects 10, according to the left part of FIG. 3, comprise information regarding traffic signs in the vicinity of the vehicle, and in order to see information regarding the traffic signs ahead of the vehicle the vehicle operator will have to change his head position in a first direction 11, as illustrated in the right part of FIG. 3. This is useful, for example, if the vehicle operator needs to decide when to overtake a vehicle in front of him.

In one example, the vehicle display arrangement 1 is arranged such that the graphical display objects 10, according to the left part of FIG. 3, comprises a message, such as an email or text message, and in order to see other messages the vehicle operator will have to change his head position in a first direction 11, as illustrated in the right part of FIG. 3.

In order to create a display area big enough to host information, a small change 11 of operator head position can be arranged to move the graphical display objects 10 in the stack such that the vehicle operator will see more of the graphical display objects 10 than he would have done if observing a physical stack from a different direction. The movement of the graphical display objects 10 in the stack is thus exaggerated in comparison with the change of head movement. This is referred to as hyperrealism.

FIG. 4 illustrates a vehicle display arrangement 1 according to some embodiments and resembles the vehicle display arrangement 1 according to FIG. 3. A control unit 9 (not shown) is arranged to automatically initiate at least one of a dimension change of graphical display objects 10 or a change of the relation between the graphical display objects 10 following a monitored predefined change of the vehicle operator head position in a second direction 12, such that previously displayed as partly hidden graphical display objects 10 are arranged to be displayed as visible in a second predefined manner. The second direction is illustrated with arrow 12 in the right part of FIG. 4. According to the embodiment illustrated in FIG. 4, the graphical display objects 10 are partly overlapping in the left part of the figure and displayed as totally visible in the right part of the figure.

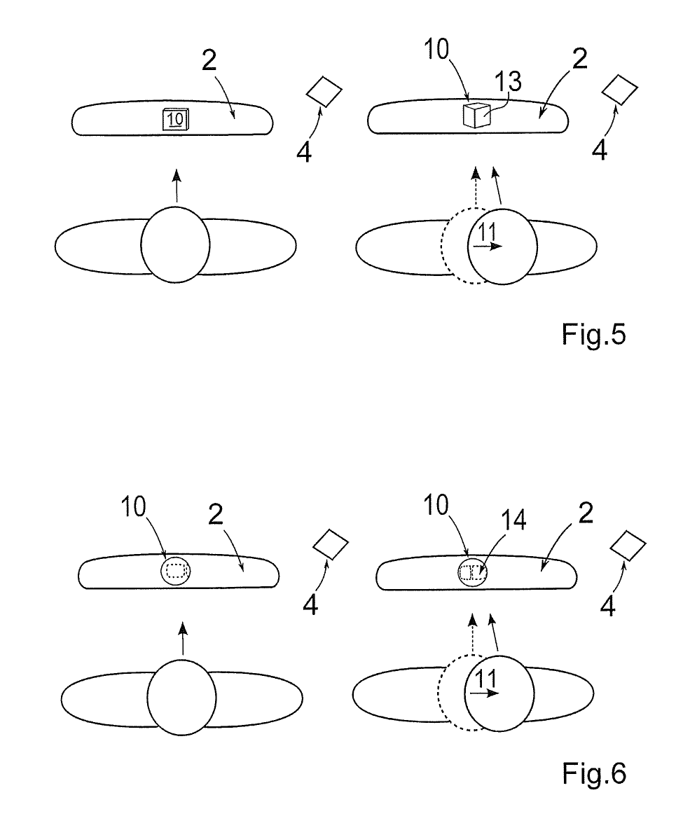

FIG. 5 illustrates a vehicle display arrangement 1 according to some embodiments. The graphical display objects 10 are arranged as a virtual cube with different sides. One side is initially facing the vehicle operator, as seen in the left part of FIG. 5. If the vehicle operator likes to gain temporary information regarding information not initially presented he will have to change his head position in a first direction 11, as illustrated in the right part of FIG. 5. The one or more sensors 4 are sensing the change of head position or gaze direction and the graphical display objects 10 are changed such that one or more, previously displayed as partly hidden, sidewalls 13 of the cube are arranged to be displayed as visible.

From the vehicle operator point of view, the cube has turned such that he can see information presented on the sidewall 13. Alternatively, the vehicle operator facing side of the cube, as seen in the left part of FIG. 5 is still facing the vehicle operator, and the sidewall 13 has turned into a displayed position.

As indicated in the left part of FIG. 5, the sidewall will be hinted or partly displayed to the vehicle operator in an ordinary driving position in order to enhance the understanding that the graphical display objects 10 are to be observed as a physical three dimensioned object.

In some embodiments, a change of vehicle driver head position upwards, downwards, forwards and/or rearwards will initiate turning of another cube wall, such as a top wall or a bottom wall.

In order to create a display area big enough to host information, a small change of operator head position will turn the virtual cube such that the vehicle operator can see more of sidewall 13 than he would have done if observing a physical cube. The turning is thus exaggerated, in comparison with the change of head movement. This is referred to as hyperrealism.

If the vehicle operator changes his head position in a second direction, another cube wall will change to be displayed as visible to the vehicle operator. Different information can be displayed on different sides of the cube, and the vehicle operator will be able to access the information by moving his head.

FIG. 6 illustrates a vehicle display arrangement 1 according to some embodiments. The graphical display objects 10 are arranged as a virtual sphere, with different sides or different side portions. One side faces the vehicle operator, as seen in the left part of FIG. 6. If the vehicle operator would like to gain temporary information regarding information not normally presented he will have to change his head position in a first direction 11, as illustrated in the right part of FIG. 6. The one or more sensors 4 senses the change of head position or gaze direction and the graphical display objects 10 are changed such that one or more, previously displayed as partly hidden, sides 14 of the sphere are arranged to be displayed as visible.

With the expression “a side of a sphere” is herein meant a predefined physical or digital surface of the sphere, such as a surface area of predefined size and location on the sphere, a predefined part of a total sphere surface or a predefined number of degrees or radians.

A vehicle operator is able to select both the information displayed by the graphical display objects 10 and the magnitude of the head movement needed to cause the change of the graphical display objects 10 according to his preferences.

In some embodiments, a change of vehicle driver head position upwards, downwards, forwards and/or rearwards is arranged to initiate a change of the graphical display objects 10. In some embodiments the predefined change of the vehicle operator head position is a translational movement, a rotational movement or a combination of translation and rotation.

With displayed as partly hidden graphical display objects 10 that are arranged to be displayed as visible, means that a visible part of the graphical display objects 10 has increased in comparison to the partly hidden configuration.

Although the aspects have been described with reference to example embodiments, many different alterations, modifications and the like will become apparent for those skilled in the art. Therefore, it is to be understood that the foregoing is illustrative of various example embodiments and the scope of the appended claims is not to be limited to the specific embodiments disclosed and that modifications to the disclosed embodiments, combinations of features of disclosed embodiments as well as other embodiments are intended to be included within the scope of the appended claims.

As used herein, the term “comprising” or “comprises” is open-ended, and includes one or more stated features, elements, steps, components or functions but does not preclude the presence or addition of one or more other features, elements, steps, components, functions or groups thereof.

What is claimed is:

1. A vehicle display arrangement comprising:
a display for displaying information to a vehicle operator;
one or more sensors for monitoring a vehicle operator head position;
a processing unit;
a control unit; and
communication means arranged to communicate input signals indicative of the vehicle operator head position to the processing unit, and to communicate output signals from the processing unit to the control unit;
wherein the processing unit is arranged to interpret the input signals and, based on the interpretation of the input signals, communicate the output signals to the control unit, the control unit being arranged to automatically initiate at least one of a dimension change of graphical display objects or a change of the relation between the graphical display objects following a monitored predefined change of the vehicle operator head position in a first direction, such that previously displayed as partly hidden graphical display objects are arranged to be displayed as visible in a first predefined manner.

2. A vehicle display arrangement according to claim 1 wherein the control unit is arranged to automatically initiate at least one of a dimension change of graphical display objects or a change of the relation between the graphical display objects following a monitored predefined change of the vehicle operator head position in a second direction such that previously displayed as partly hidden graphical display objects are arranged to be displayed as visible in a second predefined manner.

3. A vehicle display arrangement according to claim 1 wherein the control unit is arranged to automatically initiate at least one of a dimension change of graphical display objects or a change of the relation between the graphical display objects following a monitored predefined change of the vehicle operator head position in a first or second direction such that previously displayed as partly hidden graphical display objects, arranged as a side on a virtual cube, are arranged to be displayed as visible.

4. A vehicle display arrangement according to claim 1 wherein the control unit is arranged to automatically initiate at least one of a dimension change of graphical display objects or a change of the relation between the graphical display objects following a monitored predefined change of the vehicle operator head position in a first or second direction such that previously displayed as partly hidden graphical display objects, arranged as a stack, are arranged to be displayed as visible.

5. A vehicle display arrangement according to claim 1 wherein the control unit is arranged to automatically initiate at least one of a dimension change of graphical display objects or a change of the relation between the graphical display objects following a monitored predefined change of the vehicle operator head position in a first or second direction such that previously displayed as partly hidden graphical display objects, arranged as sides of a virtual sphere, are arranged to be displayed as visible.

6. A vehicle display arrangement according to claim 1 wherein the control unit is arranged to automatically initiate at least one of a dimension change of graphical display objects or a change of the relation between the graphical display objects in a first predefined manner following a monitored predefined change of the vehicle operator head position in a first or second direction, thereby being arranged to automatically display conditions in an apparatus or system in a manner that allows perception of the presentation on the display to be three dimensional.

7. A vehicle display arrangement according to claim 1 wherein the control unit is arranged to automatically initiate at least one of a dimension change of graphical display objects or a change of the relation between the graphical display objects following a monitored predefined change of the vehicle operator head position in a first direction, thereby being arranged to modify the display from a first display configuration into a second temporary display configuration.

8. A vehicle display arrangement according to claim 7 wherein the control unit is arranged to automatically initiate at least one of a dimension change of graphical display objects or a change of the relation between the graphical display objects following a monitored predefined change of the vehicle operator head position in a direction opposite the first direction, thereby being arranged to modify the display from a second temporary display configuration into the first configuration.

9. A vehicle comprising a vehicle display arrangement according to claim 1.

10. A display arrangement for a vehicle, the arrangement comprising:
a display for displaying information to a vehicle operator;
a sensor for monitoring a head position of the vehicle operator and generating input signals indicative of the vehicle operator head position; and
a control unit arranged to automatically initiate, based on an interpretation of the input signals, at least one of a dimension change of graphical display objects or a change of relation between the graphical display objects following a monitored predefined change of the vehicle operator head position in a first direction, such that graphical display objects previously displayed as partly hidden are arranged to be displayed as visible in a first predefined manner.

11. A display arrangement according to claim 10 wherein the control unit is arranged to automatically initiate at least one of a dimension change of graphical display objects or a change of the relation between the graphical display objects following a monitored predefined change of the vehicle operator head position in a second direction such that graphical display objects previously displayed as partly hidden are arranged to be displayed as visible in a second predefined manner.

12. A display arrangement according to claim 10 wherein the control unit is arranged to automatically initiate at least one of a dimension change of graphical display objects or a change of the relation between the graphical display objects following a monitored predefined change of the vehicle operator head position in a first or second direction such that graphical display objects previously displayed as partly hidden, arranged as a side on a virtual cube, are arranged to be displayed as visible.

13. A display arrangement according to claim 10 wherein the control unit is arranged to automatically initiate at least one of a dimension change of graphical display objects or a change of the relation between the graphical display objects following a monitored predefined change of the vehicle operator head position in a first or second direction such that graphical display objects previously displayed as partly hidden, arranged as a stack, are arranged to be displayed as visible.

14. A display arrangement according to claim 10 wherein the control unit is arranged to automatically initiate at least one of a dimension change of graphical display objects or a change of the relation between the graphical display objects following a monitored predefined change of the vehicle operator head position in a first or second direction such that graphical display objects previously displayed as partly hidden, arranged as sides of a virtual sphere, are arranged to be displayed as visible.

15. A display arrangement according to claim 1 wherein the control unit is arranged to automatically initiate at least one of a dimension change of graphical display objects or a change of the relation between the graphical display objects in a first predefined manner following a monitored predefined change of the vehicle operator head position in a first or second direction, thereby being arranged to automatically display conditions in an apparatus or system in a manner that allows perception of the presentation on the display to be three dimensional.

16. A display arrangement according to claim 10 wherein the control unit is arranged to automatically initiate at least one of a dimension change of graphical display objects or a change of the relation between the graphical display objects following a monitored predefined change of the vehicle operator head position in a first direction, thereby being arranged to modify the display from a first display configuration into a second temporary display configuration.

17. A display arrangement according to claim 16 wherein the control unit is arranged to automatically initiate at least one of a dimension change of graphical display objects or a change of the relation between the graphical display objects following a monitored predefined change of the vehicle operator head position in a direction opposite the first direction, thereby being arranged to modify the display from a second temporary display configuration into the first configuration.

18. A vehicle comprising a display arrangement according to claim 10.
